(19) United States
(12) Patent Application Publication
(10) Pub. No.: US 2010/0252290 A1
(43) Pub. Date: Oct. 7, 2010

(54) ADJUSTABLE AMPLITUDE HAMMER DRILL MECHANISM

(76) Inventor: Gerard M. Grand, St. Catharines (CA)

Correspondence Address: Gerard Grand, 299 Riverview Blvd., St. Catharines, ON, L2T 3N3, CA

(21) Appl. No.: 12/420,042

(22) Filed: Apr. 7, 2009

(51) Int. Cl. B25D 17/00

(52) U.S. Cl. 173/115

(57) ABSTRACT

An adjustable amplitude hammer drill mechanism comprises a main shaft having a forward drill chuck end portion and a rearward shank portion, and defining a longitudinal axis. An impact receiving member is mounted in fixed relation on the main shaft for rotation therewith. A selectively operable longitudinal-hammer member is mounted on the main shaft for free rotation of the main shaft with respect to the longitudinal-hammer member and for operative engagement with the impact receiving member. Rotation of the main shaft and impact receiving member about the longitudinal axis when the longitudinal-hammer member is in force transmitting engagement with the impact receiving member, causes the longitudinal-hammer member to move in a reciprocating motion between the forwardly displaced position and the rearwardly displaced position, and transmits impact forces forwardly along the longitudinal axis to the main shaft. There is also an amplitude adjustment assembly for mounting the selectively operable longitudinal-hammer member in the operative engagement with the impact receiving member.

### FIELD OF THE INVENTION

The present invention relates to hammer drills mechanisms, and more particularly to adjustable amplitude hammer drill mechanisms.

### BACKGROUND OF THE INVENTION

Hammer drills are well known and are typically used, even by home craftsmen, to drill holes in relatively hard substances, such as concrete and the like. Such hammer drills typically have a rotating spindle that drives the drill chuck. An impact receiving member is secured to the rotations spindle. A hammer member engages the impact receiving member as the spindle rotates, so as to provide the hammer drill function. Although hammer drills do work, they present a limitation in that in most hammer drills the impact created by the engagement of the hammer member and the receiving member is not adjustable.

One such example of an adjustable hammer drill can be found in United States Published Patent Application 2007/0039747, published Feb. 22, 2007, to Stirm, which discloses a hammer drill that includes a housing; a motor mounted within the housing; and a tool holder rotatably mounted on the house for holding a cutting tool. A striker is mounted in a freely slideable manner within the housing, for repetitively striking an end of a cutting tool when a cutting tool is held by the tool holder. The striker is reciprocatingly driven by the motor, when the motor is activated, via a drive mechanism. The drive mechanism comprises a pivoting drive arm pivotally mounted within the housing at one end and which is drivingly connected to the striker; a pivotal drive mechanism connected to the pivoting drive arm and which converts a rotary movement generated by the motor into an oscillating pivotal movement of the pivoting drive arm. The amplitude of the oscillations of the pivoting drive arm can be adjusted.

It is an object of the present invention to provide an adjustable hammer drill mechanism.

It is a further object of the present invention to provide an adjustable hammer drill mechanism that is inexpensive to manufacture.

It is yet a further object of the present invention to provide an adjustable hammer drill mechanism that can be used in an attachment for a drill.

It is yet a further object of the present invention to provide an adjustable hammer drill mechanism that can be used in a drill.

### SUMMARY OF THE INVENTION

In accordance with one aspect of the present invention there is disclosed a novel adjustable amplitude hammer drill mechanism comprising a main shaft having a forward drill chuck end portion and a rearward shank portion, and defining a longitudinal axis. An impact receiving means is mounted in fixed relation on the main shaft for rotation therewith. A selectively operable longitudinal-hammer means is mounted on the main shaft for free rotation of the main shaft with respect to the longitudinal-hammer means and for operative engagement with the impact receiving means. Rotation of the main shaft and impact receiving means about the longitudinal axis when the longitudinal-hammer means is in force transmitting engagement with the impact receiving means, causes the longitudinal-hammer means to move in a reciprocating motion between the forwardly displaced position and the rearwardly displaced position, and transmits impact forces forwardly along the longitudinal axis to the main shaft. There is also an amplitude adjustment means for mounting the selectively operable longitudinal-hammer means in the operative engagement with the impact receiving means.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the hammer drill bit and hammer drill bit chuck attachment according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view from the front of the first preferred embodiment of the adjustable amplitude hammer drill mechanism according to the present invention;

FIG. 2 is a partially cut-away side elevational view of the first preferred embodiment adjustable amplitude hammer drill mechanism of FIG. 1, with the ball bearings of the longitudinal-hammer member fully engaged with the ball bearings of the impact receiving member;

FIG. 3 is a partially cut-away side elevational view of the first preferred embodiment adjustable amplitude hammer drill mechanism of FIG. 1, with the ball bearings of the longitudinal-hammer member riding over the ball bearings of the impact receiving member;

FIG. 4 is an exploded side elevational view of the first preferred embodiment adjustable amplitude hammer drill mechanism of FIG. 1;

FIG. 5 is an enlarged side elevational view of a portion of the first preferred embodiment adjustable amplitude hammer drill mechanism of FIG. 1, with the ball bearings of the longitudinal-hammer member fully engaged with the ball bearings of the impact receiving member;

FIG. 6 is an enlarged side elevational view of a portion of the first preferred embodiment adjustable amplitude hammer drill mechanism of FIG. 1, with the ball bearings of the longitudinal-hammer member partially engaged with the ball bearings of the impact receiving member;

FIG. 7 is an enlarged side elevational view of a portion of the first preferred embodiment adjustable amplitude hammer drill mechanism of FIG. 1, with the ball bearings of the longitudinal-hammer member slightly engaged with the ball bearings of the impact receiving member;

FIG. 8 is a cut-away side elevational view of the second preferred embodiment of the adjustable amplitude hammer drill mechanism according to the present invention.

### DETAILED DESCRIPTION OF THE PREFERRED EMBODIMENTS

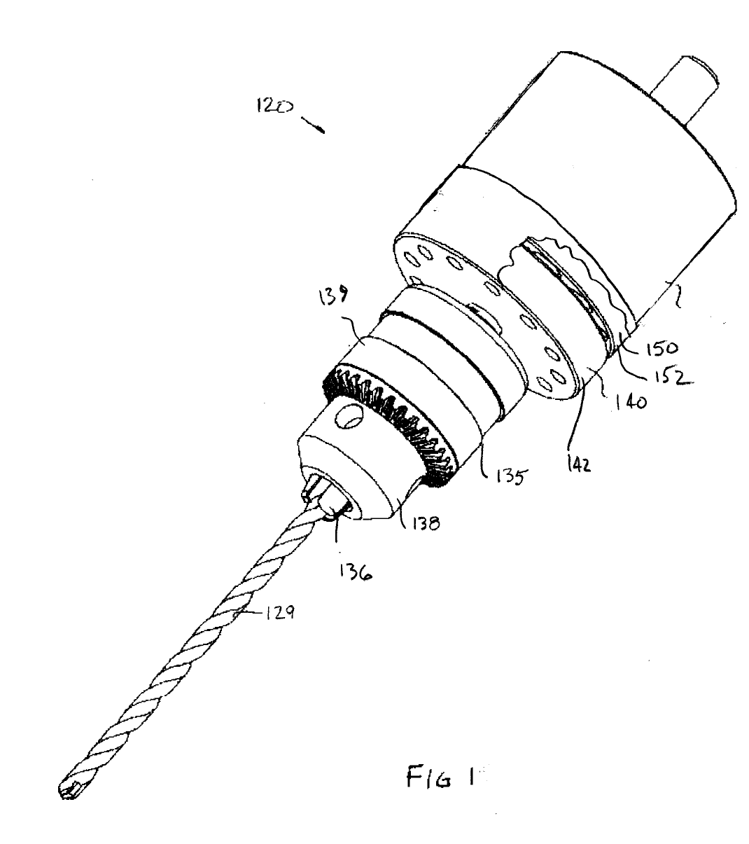

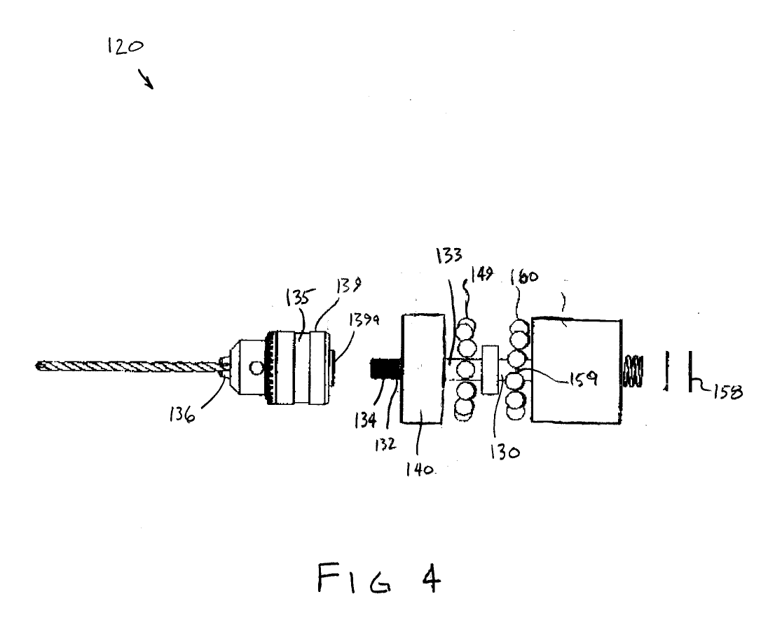

Referring to FIGS. 1 through 8 of the drawings, it will be noted that FIGS. 1 through 7 illustrate a first preferred embodiment of the adjustable amplitude hammer drill mechanism of the present invention, and FIG. 8 illustrates a second preferred embodiment of the adjustable amplitude hammer drill mechanism of the present invention.

Reference will now be made to FIGS. 1 through 7, which show a first preferred embodiment of the adjustable amplitude hammer drill mechanism of the present invention, as indicated by general reference numeral 120. Fundamentally, the adjustable amplitude hammer drill mechanism 120 comprises a main shaft 130, an impact receiving means 140, a longitudinal-hammer means 150, and an amplitude adjustment means 170, as will be described in greater detail below.

The adjustable amplitude hammer drill mechanism 120 comprises a main shaft 130 having a threaded forward drill chuck end portion 132, an intermediate shank portion 133, and a rearward shank portion 134. The main shaft 130 defines a longitudinal axis “L” about which the main shaft 130 rotates. The first preferred embodiment adjustable amplitude hammer drill mechanism 120 comprises an attachment and the main shaft 130 is engageable in a rotatable chuck of a conventional drill (not specifically shown).

A drill bit chuck 135 is mountable on the forward drill chuck end portion 132 of the main shaft 130 for rotation therewith, as can be best seen in FIGS. 1 through 4. The drill bit chuck 135 is a conventional drill bit chuck and comprises three movable jaw members 136 that receive and retain a conventional drill bit 129 therein. A ferrule member (not specifically shown) surrounds the jaw members 136 and is wedged between the jaw members 136 and an outer housing 138 to keep the jaw members 136 locked in place on the conventional drill bit 129. A base member 139 is secured in place on the outer housing 138 and the back end 136b of the jaw members 136. The base member 139 has a threaded bore hole 139a that receives a co-operating threaded forward portion 134 of the forward drill chuck end portion 132 of the main shaft 130 in secure engagement.

An impact receiving means 140 comprises a main body portion 142, a forwardly facing surface 145, a rearward facing surface 146 and at least one impact portion. In the first preferred embodiment, as illustrated, the at least one impact portion comprises a plurality of ball bearings 149. Alternatively, it is contemplated that other types of impact portions could be used. As illustrated, the ball bearings 149 are substantially evenly spaced around the rearwardly facing surface 146 of the impact receiving means 140 about the longitudinal axis “L”.

The impact receiving means 140 is mounted in fixed relation on the main shaft 130 for rotation therewith, and projects radially outwardly from the intermediate shank portion 133. The impact receiving means 140 is threadibly engaged on the intermediate shank portion 133 the main shaft 130. The threads of the co-operating threaded forward portion 134 of the forward drill chuck end portion 132 of the main shaft 130 co-operatingly aligned with each other such that the impact receiving means 140 can be threadibly engaged from the forward drill chuck end portion 132 to the intermediate shank portion 133.

Alternatively, the rearward facing impact surface 146 may be integrally formed on the main body portion 142.

A selectively opeable longitudinal-hammer means 150 comprises a main body member 152 and a forwardly facing surface 156. The longitudinal-hammer means 150 is mounted on the main shaft 130, mostly at the rearward shank portion 134 rearwardly of the impact receiving means 140, for free rotation about the main shaft 130 with respect to the longitudinal-hammer means 150, and for operative engagement with the impact receiving means 140. In the preferred embodiment, as illustrated, the longitudinal-hammer means 150 is retained on the rearward shank portion 134 by means of a “C”-clip 158 securely engaged in an annular slot 159 in the rearward shank portion 134. Other suitable means may also be used. The section of the rearward shank portion 134 disposed rearwardly of the impact receiving means 140 must be of sufficient length to be securely received in the bit chuck of a conventional electric drill.

In the first preferred embodiment, as illustrated, the selectively operable longitudinal-hammer means 150 comprises a hammer ball bearing assembly 150 having a plurality of forwardly projecting ball bearings 160. The plurality of ball bearings 160 in the hammer ball bearing assembly 150 are disposed in evenly radially spaced relation around the longitudinal axis “L”.

The impact receiving means 140 comprises an impact ball bearing assembly having a plurality of rearwardly projecting ball bearings 149. The plurality of ball bearings 149 in the impact ball bearing assembly 140 are disposed in evenly radially spaced relation around the longitudinal axis “L”.

Preferably, the number of ball bearings 160 in the hammer ball bearing assembly 150 is equal to the number of ball bearings 149 in the impact ball bearing assembly 140.

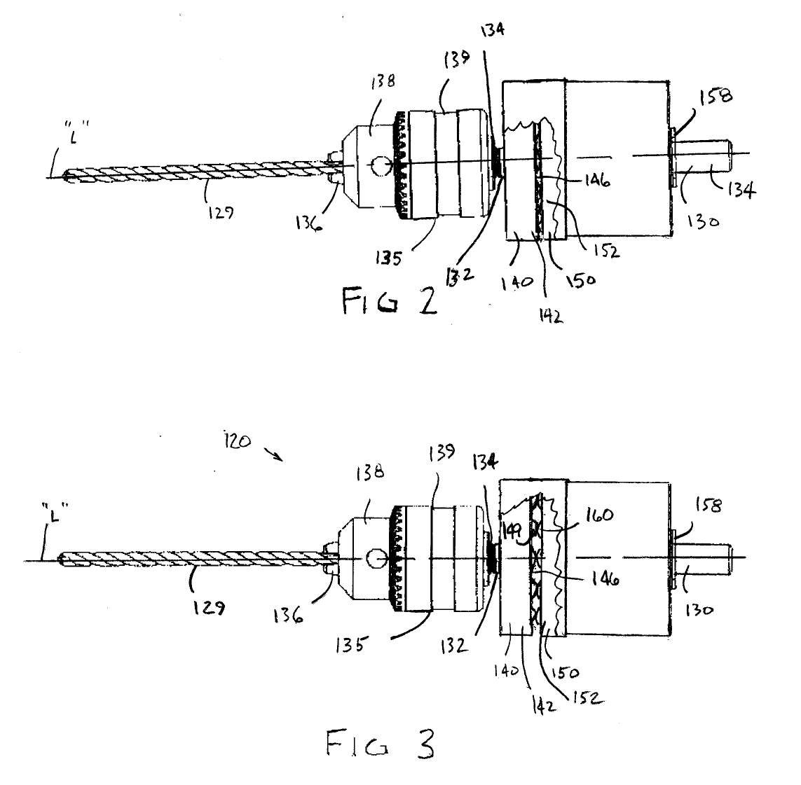

Rotation of the main shaft 130 and impact receiving means 140 about the longitudinal axis “L” when the longitudinal-hammer means 150 is in force transmitting engagement with the impact receiving means 140, causes the longitudinal-hammer means 150 to move in a slight reciprocating motion, as shown in FIGS. 2 and 3, as will now be described. During rotation of the main shaft 130 and the impact receiving means 140 about the longitudinal axis “L”, the plurality of ball bearings 160 of the longitudinal-hammer means 150 engage the plurality of ball bearings 149 of the impact receiving means 140, as the main shaft 130 rotates with respect to the longitudinal-hammer means 150, as would occur during normal use of an electric drill (not shown). The longitudinal-hammer means 150 is thereby caused to move in a longitudinal reciprocating motion between a fully engaged configuration, as shown in FIG. 2, and a transitional configuration whereat the the ball bearings 160 of the longitudinal-hammer member are riding over the ball bearings 149 of the impact receiving member 140. In this manner, the ball bearings 160 impart reciprocating motion along the longitudinal axis “L” to the main shaft 130, to thereby transmit impact forces forwardly along the longitudinal axis “L” to the main shaft 130, and therefore to the conventional drill bit 129. It would be readily understood by one skilled in the art that the ball bearings 160 generally ride along the ball bearings 149, and may impact all of the ball bearings 149, or impacts only higher portions of the ball bearings 149, depending on the speed of rotation of the impact receiving means 140 with respect with the longitudinal-hammer means 150.

The height, radius of curvature, shape and number of ball bearings 160 and the ball bearings 149 will affect the frequency and amplitude of the impacts of the ball bearings 160 on the ball bearings 149.

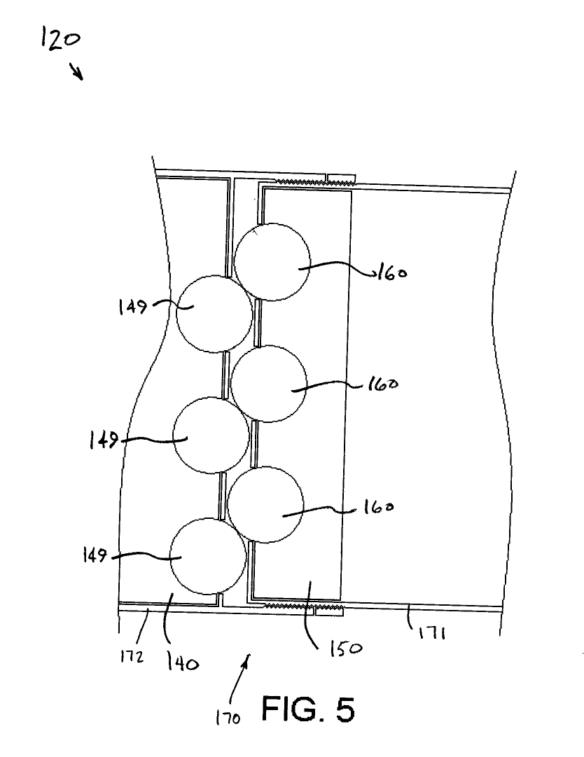

The first preferred embodiment of the adjustable amplitude hammer drill mechanism 120 further comprises an amplitude adjustment means, as indicated by the general reference numeral 170, for mounting the selectively operable longitudinal-hammer means 150 in the operative engagement with the impact receiving means 140. The amplitude adjustment means 170 comprises a carrier member 171 for the selectively operable longitudinal-hammer means 150 and a receiving member 172 for the impact receiving means 140, and wherein the carrier member 171 is mounted on the receiving member 172 for movement along the longitudinal axis “L” between a plurality of engagement positions as can be seen in FIGS. 5 through 7. The carrier member 171 and the receiving member 172 are threadibly engaged one with the other.

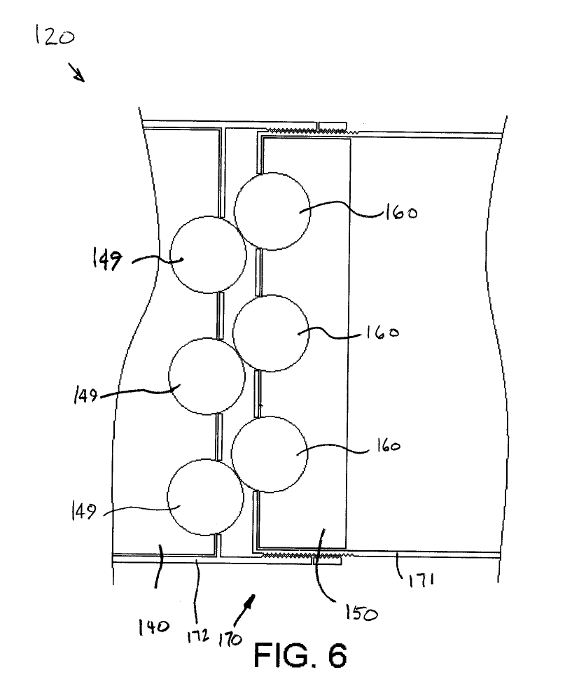

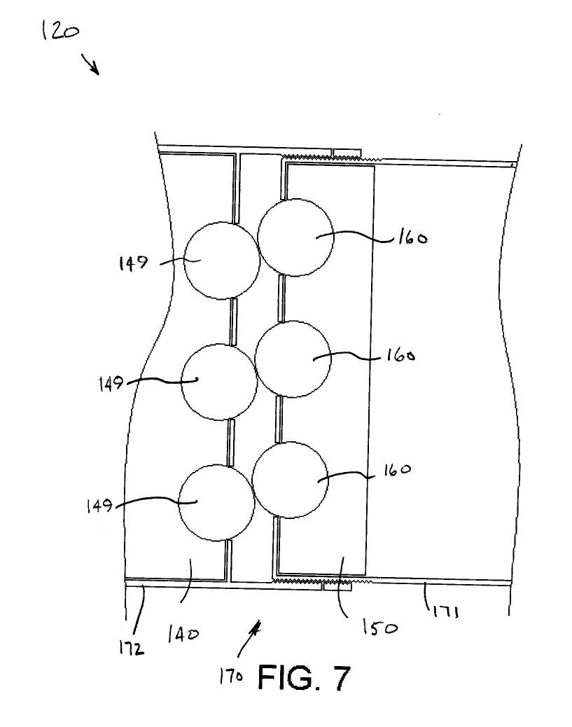

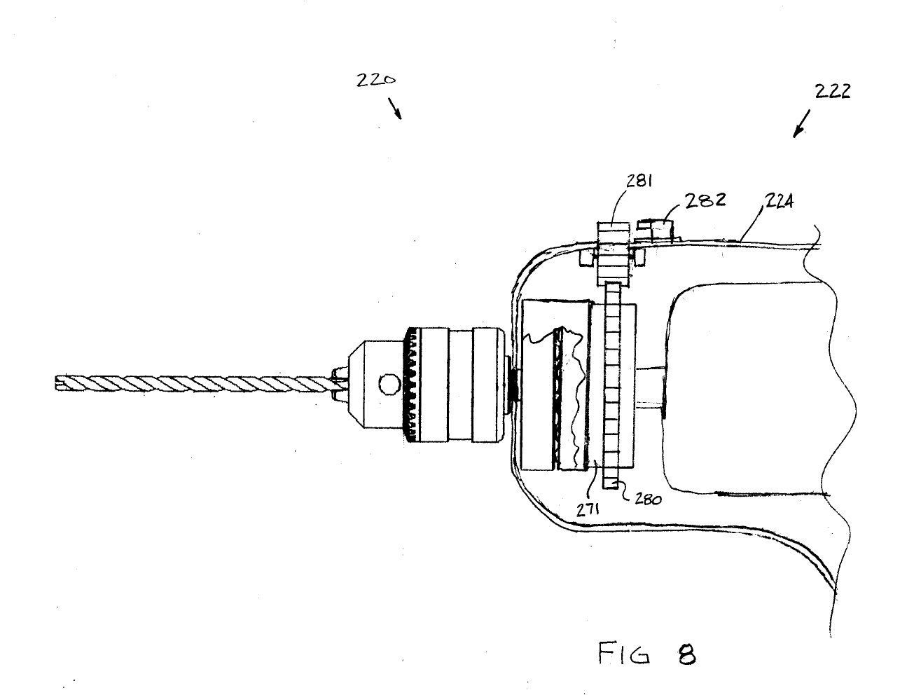

Reference will now be made to FIGS. 5 through 7, which show the longitudinal means 150, and particularly the carrier member 171, threadibly engaged with the impact receiving means 140, and particularly the receiving member 172, in various levels of amplitude adjustment. In FIG. 5, the ball bearings 160 of the longitudinal hammer means 150 are fully engaged with the ball bearings 149 of the impact receiving means 140. In FIG. 6, the ball bearings 160 of the longitudinal hammer means 150 are partially engaged with the ball bearings 149 of the impact receiving means 140. In FIG. 7, the ball bearings 169 of the longitudinal hammer means 150 are slightly engaged with the ball bearings 149 of the impact receiving means 140. In this manner, the adjustable amplitude hammer drill mechanism 120 is selectively adjustable.

The first preferred embodiment of the adjustable amplitude hammer drill mechanism 120 further comprises a locking collar 180 threadibly engaged on one of the carrier member 171 and the receiving member 172. More specifically, the locking collar 180 is threadibly engaged on the carrier member 171.

As described above, the conventional drill bit 129 is caused to “hammer” into a piece of material as it rotates, thus causing a drill hole to be drilled readily even into hard materials, such as cement or concrete. It should also be noted that the electric drill itself does not absorb the reaction of the impact of the ball bearings 160 of the selectively operable longitudinal-hammer means 150, on the ball bearings 149 of the impact receiving means 140.

More importantly, it has been found that with the adjustable amplitude hammer drill mechanism 120 of the present invention, there is reduced friction, reduced heat build up, reduced wear and improved drilling performance compared with non-adjustable conventional hammer drills, when performing functions where reduced impact is sufficient. Heat build up is of particular concern under IEC 60745-1:2001, as adopted by UL, CSA and other national governing bodies regulating safety in hand held power tools and accessories. An electric drill using the present invention experiences very minimal loss of speed due to the reduced friction between the ball bearings 160 and the impact receiving means 140. Accordingly, the rotational energy is directed to the actual longitudinal vibration, and not to losses due to friction and heat.

Reference will now be made to FIG. 8, which shows a second preferred embodiment of the adjustable amplitude hammer drill mechanism of the present invention, as indicated by general reference numeral 220. The second preferred embodiment adjustable amplitude hammer drill mechanism 220 is similar to the first preferred embodiment adjustable amplitude hammer drill mechanism 120 except that the adjustable amplitude hammer drill mechanism 220 comprises part of a drill 222. The second preferred embodiment adjustable amplitude hammer drill mechanism 220 further comprises an adjustment gear means 280 disposed on the outer periphery of the carrier member 271 for rotation therewith, and a manually rotatable gear member 281 mounted on the drill 222 so as to project exteriorly to the housing 224 of the drill 222. Rotation of the manually rotatable gear member 281 correspondingly rotates the adjustment gear means 280 on the carrier member 271. There is also a locking means 282 mounted on the drill 222. The locking means 282 is movable between a locking position whereat the manually rotatable gear member 281 is precluded from being rotated and a release position whereat the manually rotatable gear member 281 is permitted to be rotated.

As can be understood from the above description and from the accompanying drawings, the present invention provides a adjustable amplitude hammer drill mechanism that is inexpensive to manufacture, that is robust, wherein the frequency and amplitude of impacts can be adjusted or selected, wherein heat build up is minimized, and wherein an electric drill used in conjunction with the adjustable amplitude hammer drill mechanism can be operated at lower rotational speeds, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the hammer drill bit and adjustable amplitude hammer drill mechanism of the present invention without departing from the spirit and scope of the accompanying claims.

I claim:

1. An adjustable amplitude hammer drill mechanism comprising:
a main shaft having a forward drill chuck end portion and a rearward shank portion, and defining a longitudinal axis;
an impact receiving means mounted in fixed relation on said main shaft for rotation therewith;
a selectively operable longitudinal-hammer means mounted on said main shaft for free rotation of said main shaft with respect to said longitudinal-hammer means and for operative engagement with said impact receiving means;
wherein rotation of said main shaft and impact receiving means about said longitudinal axis when said longitudinal-hammer means is in force transmitting engagement with said impact receiving means, causes said longitudinal-hammer means to move in a reciprocating motion between said forwardly displaced position and said rearwardly displaced position, and transmits impact forces forwardly along said longitudinal axis to said main shaft; and,
an amplitude adjustment means for mounting said selectively operable longitudinal-hammer means in said operative engagement with said impact receiving means.

2. The adjustable amplitude hammer drill mechanism of claim 1, wherein said amplitude adjustment means comprises a carrier member for said selectively operable longitudinal-hammer means and a receiving member for said impact receiving means, and wherein said carrier member is mounted on said receiving member for movement along said longitudinal axis between a plurality of engagement positions.

3. The adjustable amplitude hammer drill mechanism of claim 2, wherein said carrier member and said receiving member are threadibly engaged one with the other.

4. The adjustable amplitude hammer drill mechanism of claim 3, further comprising a locking collar threadibly engaged on one of said carrier member and said receiving member.

5. The adjustable amplitude hammer drill mechanism of claim 4, wherein said locking collar is threadibly engaged on said carrier member.

6. The adjustable amplitude hammer drill mechanism of claim 1, wherein said selectively operable longitudinal-hammer means comprises a hammer ball bearing assembly having a plurality of forwardly projecting ball bearings.

7. The adjustable amplitude hammer drill mechanism of claim 6, wherein said impact receiving means comprises an impact ball bearing assembly having a plurality of rearwardly projecting ball bearings.

8. The adjustable amplitude hammer drill mechanism of claim 7, wherein said plurality of ball bearings in said hammer ball bearing assembly are disposed in evenly radially spaced relation around said longitudinal axis, and said plurality of ball bearings in said impact ball bearing assembly are disposed in evenly radially spaced relation around said longitudinal axis.

9. The adjustable amplitude hammer drill mechanism of claim 8, wherein the number of ball bearings in said hammer ball bearing assembly is equal to the number of ball bearings in said impact ball bearing assembly.

10. The adjustable amplitude hammer drill mechanism of claim 1, wherein said adjustable amplitude hammer drill mechanism comprises an attachment and said main shaft is engageable in a rotatable chuck.

11. The adjustable amplitude hammer drill mechanism of claim 1, wherein said adjustable amplitude hammer drill mechanism comprises part of a drill.

12. The adjustable amplitude hammer drill mechanism of claim 11, further comprising adjustment gear means disposed on the outer periphery of said carrier member for rotation therewith, and a manually rotatable gear member mounted on said drill so as to project exteriorly to the housing of said drill, and wherein rotation of said manually rotatable gear member correspondingly rotates said adjustment gear means on said carrier member.

13. The adjustable amplitude hammer drill mechanism of claim 12, further comprising a locking means mounted on said drill, wherein said locking means is movable between a locking position whereat said manually rotatable gear member is precluded from being rotated and a release position whereat said manually rotatable gear member is permitted to be rotated.
